(19) United States
(12) Patent Application Publication
(10) Pub. No.: US 2018/0134520 A1
(43) Pub. Date: May 17, 2018

(54) ARRANGEMENT AND METHODS FOR CONDITION MONITORING OF THE TRACTION BELT AND/OR THE TRACTION BELT TERMINATION

(71) Applicant: Kone Corporation, Helsinki (FI)

(72) Inventors: Janne MIKKONEN, Helsinki (FI); Esko AULANKO, Helsinki (FI); Markku HAAPANIEMI, Helsinki (FI); Matti RASANEN, Helsinki (FI)

(73) Assignee: Kone Corporation, Helsinki (FI)

(21) Appl. No.: 15/869,277

(22) Filed: Jan. 12, 2018

Related U.S. Application Data
(63) Continuation of application No. PCT/FI2015/050540, filed on Aug. 21, 2015.

(51) Int. Cl. B66B 7/12; B66B 7/06; B66B 7/08; B66B 3/00; G01L 5/10; D07B 1/14

(52) U.S. Cl. CPC B66B 7/1223; B66B 7/062; B66B 7/08; D07B 1/145; G01L 5/10; D07B 1/147; B66B 3/002

(57) ABSTRACT

An arrangement for condition monitoring of a traction belt and/or termination of a traction belt, wherein the arrangement comprises at least two independent condition monitoring means. The invention contains independent claims also for methods for the condition monitoring of the traction belt and/or termination of the traction belt, as well as a method for evaluating the way how traction belts wear, and an elevator.

This application is a continuation of PCT International Application No. PCT/FI2015/050540 which has an International filing date of Aug. 21, 2015, the entire contents of which are incorporated herein by reference.

### FIELD OF THE INVENTION

The invention relates to the field of elevator technology, in general to elevator safety and in particular condition monitoring of traction belts and/or currently their termination used in elevators.

### BACKGROUND ART

The traction belt condition monitoring in an elevator is achieved by the belt tension monitor means integrated to the belt tensioning system. The belt tension monitoring means have a spring-loaded switch which detects if the tension of the traction belt falls.

### OBJECTIVE OF THE INVENTION

The aspects of the invention relates to an arrangement and methods for condition monitoring of the traction belt and/or the traction belt termination, to a method for evaluating the way how traction belts wear, and to an elevator.

The first objective of the present invention is to improve reliability of condition monitoring of the traction belt of an elevator and/or termination of the traction belt.

This objective can be fulfilled with an arrangement according to claim 1 for the condition monitoring of the traction belt of an elevator and/or the termination of the traction belt and with a method according to the claim 13 and/or according to claim 17.

A second objective of the invention is to enable using only one traction belt instead of two or more traction belts and despite of this to still maintain suitable redundancy in detection of possible failures of a traction belt or its termination. This objective can be fulfilled with an elevator according to claim 14.

A third objective of the invention is to improve the method how to find out the way how the traction belts wear.

This objective can be resolved with a method according to claim 16.

The dependent claims describe advantageous embodiments of the arrangement and of the methods for the condition monitoring of the traction belt of an elevator and/or the traction belt termination, of the method for evaluating the way how traction belts wear, and of the elevator.

### Advantages of the Invention

The arrangement for condition monitoring of a traction belt of an elevator and/or a termination of a traction belt comprises at least two independent condition monitoring means, it is possible to improve reliability of condition monitoring of the traction belt of an elevator and/or termination of the traction belt, because if one condition monitoring means fails or breaks another condition monitoring means is still working and gives more time to react.

Preferably the condition monitoring means for condition monitoring of a traction belt of an elevator comprise at least two steel ropes inside the traction belt. The steel ropes cover the entire length between the opposite ends of the traction belt and are divided or dividable to at least two independent groups. The condition monitoring means for condition monitoring of a traction belt of an elevator further comprise a means for measuring the electric resistance of the steel ropes of each independent group. Furthermore the means for measuring the electric resistance of the steel ropes of each independent group are configured to detect condition or rupturing of the traction belt. In this manner, it is possible to improve reliability of condition monitoring of the traction belt of an elevator because information of rupturing of the traction belt is available for condition monitoring control immediately.

When the steel ropes inside each independent group are connected or connectable in series to enable measuring the electric resistance at only one end of the traction belt, it is possible to measure the electric resistance of each independent group at the same time and at the same location and furthermore, the condition monitoring of a traction belt of an elevator can be monitored over the entire length of the traction belt.

When the condition monitoring means further comprise a condition monitoring means to which at least one monitoring limit for the electric resistance of the steel ropes of each independent group is determined or determinable, it is possible to set an initial value for measuring the electric resistance of each independent group before the first startup with the traction belt. The initial value can be reference to later electric resistance measuring.

When the limit or at least one of said limits is a warning limit it is possible to get warning information of a maintenance need immediately when the measured electric resistance exceeds the warning limit. When the limit or at least one of said limits is an alarm limit, it is possible to get alarm information of the maintenance or interception needs immediately when the measured electric resistance exceeds the alarm limit.

When the means for the electric resistance measure comprises a connector at the end of traction belt making group-wise an electric connection between the groups and the means for measuring the electric resistance, it is possible to connect means for electric resistance measuring to each independent group of the traction belt.

When the connector is a comb-like connector, it is possible to connect individual steel ropes to the means for measuring the electric resistance of the steel ropes.

Preferably the condition monitoring means for the condition monitoring of a termination of traction belt comprise a prime clamp, at least one supplementary clamp and a monitoring switch between the prime clamp and the supplementary clamp. The condition monitoring means for the condition monitoring of a termination of traction belt further comprise at least one traction belt forming a slack bend at the location of the monitoring switch. The slack bend of the traction belt and the monitoring switch are mutually so positioned that a rupture of the prime clamp causes the traction belt to change a switch state of the monitoring switch. In this manner, it is possible to improve reliability of condition monitoring of termination of the traction belt because information of a failure in termination of the traction belt is available for condition monitor control immediately.

When the monitoring switch is connected or connectable to the means for measuring the electric resistance of the steel ropes of each independent group, it is possible to send a control signal from the monitoring switch or microcontroller to the elevator control via the same electric cables as the means for measuring the electric resistance of the steel ropes and in such a way reduce the number of the electric cables.

When the supplementary clamp is duplicated or duplicable for each independent group, it is possible to improve reliability of condition monitoring of termination of the traction belt even more because in this way the end of traction belt has own supplementary clamp for each independent group instead of one supplementary clamp for two or more independent groups.

When the traction belt is a toothed belt, it is possible to avoid the slipping drawback of the conventional fully flat belt and at the same time the toothed belt ensure a proper traction.

When in a method for condition monitoring of the traction belt of an elevator and/or a termination of a traction belt the arrangement of the first aspect of the present invention is used for condition monitoring of a traction belt of an elevator and/or a termination of a traction belt, it is possible to improve reliability of condition monitoring of the traction belt of an elevator and/or termination of the traction belt. The reliability of condition monitoring of the traction belt can be improved when measuring the electric resistance of the ropes, which are divided in at least two independent groups inside the traction belt. A variety of the electric resistance detects condition or rupturing of the traction belt. The reliability of condition monitoring of termination of the traction belt can be improved when adding more termination clamps with monitoring switch to the end of the traction belt for detecting a failure in termination of the traction belt immediately.

When an elevator comprises a hoistway, at least one elevator unit movable in the hoistway, including at least one elevator car, lifting means comprising a lift device, one or more suspension ropes and at least one traction belt and an arrangement for condition monitoring of a traction belt of an elevator and/or a termination of a traction belt according to the first aspect of the present invention, it is possible to use only one traction belt instead of two or more traction belts and maintain suitable redundancy in detection of possible failures of a traction belt or its termination.

When the elevator comprises only one traction belt, it is possible to use only one traction belt instead of two or more traction belts and despite of this to still maintain suitable redundancy in detection of possible failures of a traction belt or its termination.

When in a method for evaluating the way how traction belts wear the electric resistance values of each independent group of at least two traction belts are compared to find out the way how the traction belts wear, it is possible to compare and collect data from the wearing of the traction belts in different environments and load conditions. According to this data is also possible to anticipate maintenance need.

With the method for condition monitoring of a traction belt and/or a termination of traction belt wherein i) the traction belt and/or termination of traction belt is divided in portions and each portion is capable to carry at least the intended load of the traction belt, ii) at least one criterion for each of the portions of the traction belt and/or the termination of traction belt is set to judge a failure, and iii) if one or more such a criterion is met then a failure in capacity to carry the load is indicated, it is possible to use only one traction belt instead of two or more traction belts and maintain suitable redundancy in detection of possible failures of a traction belt or its termination.

With the wherein the traction belt is divided in portions by dividing steel ropes of the traction belt at least two independent groups, measuring the electric resistance of the steel ropes of each independent group and detecting condition or rupturing of the traction belt by the means for measuring the electric resistance of the steel ropes of each independent group, it is possible to maintain suitable redundancy in detection of possible failures of a traction belt.

With the method wherein the termination is divided in portions by installing a prime clamp, at least one supplementary clamp, a monitoring switch between the prime clamp and the supplementary clamp and at least one traction belt forming a slack bend at the location of the monitoring switch, and furthermore wherein the slack bend of the traction belt and the monitoring switch are positioned mutually so that a rupture of the prime clamp causes the traction belt to change a switch state of the monitoring switch, it is possible to maintain suitable redundancy in detection of possible failures of a traction belt termination.

With the method wherein the termination is divided in portions by duplicating the supplementary clamp for each independent group, it is possible to maintain suitable redundancy in detection of possible failures of a traction belt or its termination.

With the method wherein the load is intended in elevator control, it is possible to set the intended load case-by-case.

With the method wherein the criterion is set in elevator control, it is possible to set the criterion case-by-case.

### LIST OF DRAWINGS

The arrangement is explained in more detail in the following by way of the exemplary embodiments shown in the attached drawings in FIG. 1 to 5.

In the drawings:

FIG. 1 is a schematic drawing of an arrangement of the condition monitoring means for condition monitoring of a traction belt wherein the ropes of the traction belt are divided in two independent monitoring groups;

FIG. 2 is a perspective view of a traction belt with comb-like connectors and wherein the ropes of the traction belt are divided to two independent monitoring groups;

FIG. 3 is a perspective view of the end of a traction belt with two clamps and a control switch and wherein the ropes of the traction belt are divided in two independent monitoring groups;

FIG. 4 is a perspective view from the left side of a traction belt with two belt clamps and a control switch and wherein the ropes of the traction belt are divided to two independent monitoring groups;

FIG. 5 is a perspective view of the embodiment of the traction belt with two belt clamps and a control switch and wherein supplementary clamp is doubled to two supplementary clamps;

Similar parts are marked with identical reference numbers in all FIG.

### DETAILED DESCRIPTION

A conventional way to carry out redundancy in monitoring suitable condition of traction belts of an elevator is to equip the elevator with at least two parallel belts and monitor them separately. For carrying the loads, taking account to required safety factors it is technically possible to equip elevator with only one traction belt, particularly if 2:1 or higher suspension ratios are used.

An arrangement 20 for condition monitoring of a traction belt 1 of an elevator and/or a termination of a traction belt 1 comprises at least two independent condition monitoring means 13, 14. The condition monitoring means 13 are for condition monitoring of a rupturing of the traction belt 1 of an elevator and condition monitoring means 14 are for condition monitoring of a failure of the traction belt 1. The condition monitoring means 13 can be doubled as well as the condition monitoring means 14. It is possible to use condition monitoring means 13 and 14 separately or combined arbitrarily.

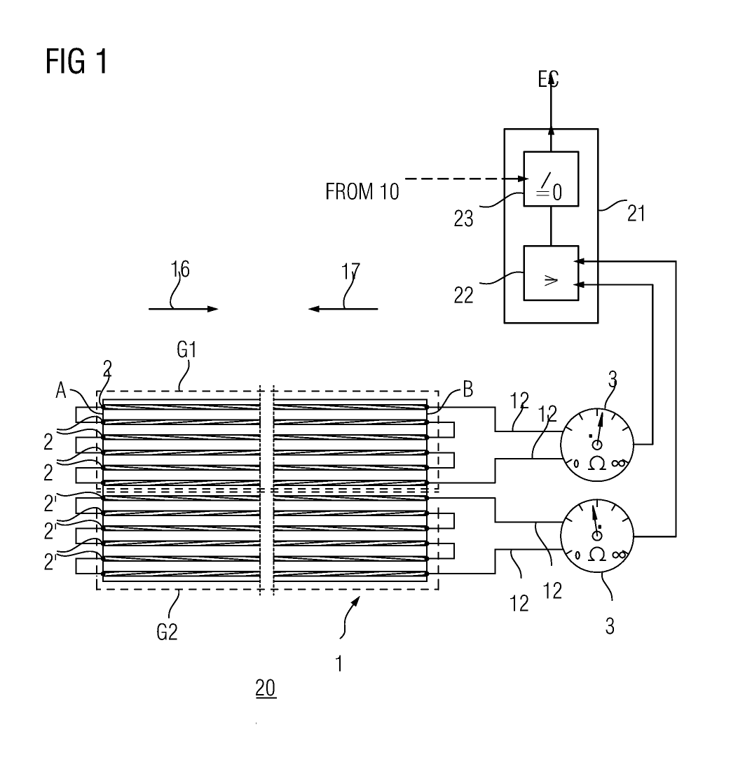

FIG. 1 shows a schematic drawing of the arrangement 20 of the condition monitoring means for condition monitoring of the traction belt of an elevator. The condition monitoring means 13 preferably comprise at least two steel ropes 2,2′ inside the traction belt 1, which steel ropes 2, 2′ are divided or dividable in at least two independent groups G1, G2 and a means 3 for measuring the electric resistance of the steel ropes 2, 2′ of each independent group G1, G2. The means 3 for measuring the electric resistance of steel ropes 2, 2′ of each independent group G1, G2 are configured to detect condition or rupturing of the traction belt 1.

The steel ropes 2, 2′ inside each independent group G1, G2 are preferably connected or connectable in series to enable measuring the electric resistance only at one end A, B of the traction belt 1. Electric cables 12 connecting the steel ropes 2, 2′ to the means 3 for measuring the electric resistance. The electric cables 12 are therefore preferably only in one end A, B of the traction belt 1. The condition of a traction belt 1 of an elevator can be monitored over the entire length of the traction belt 1, since the steel ropes 2, 2′ cover the entire length between the opposite ends A, B of the traction belt 1.

The condition monitoring means 13 further comprise a condition monitoring means 22 to which at least one monitoring limit 4 for the electric resistance of the steel ropes 2, 2′ of each independent group G1, G2 is determined or determinable. The electric resistance of a steel rope 2, 2′ changes when the steel rope 2, 2′ wears out, rupturing or if any cord of the steel rope 2, 2′ breaks off. It is possible to measure and detect the changes of the electric resistance and determine the monitoring limits for warning and alarm and proceed specified actions according the set limits. The electric resistance can either increase or decrease because of the rupture of the traction belt. A ±10% change in electric resistance referring to the initial value (traction belt is new and installed) may be defined as the warning limit and a ±20% change as the alarm limit. When comparing the traction belts 1 and electric resistance values of each independent group G1, G2, it is possible to find out the way how the traction belts 1 wear.

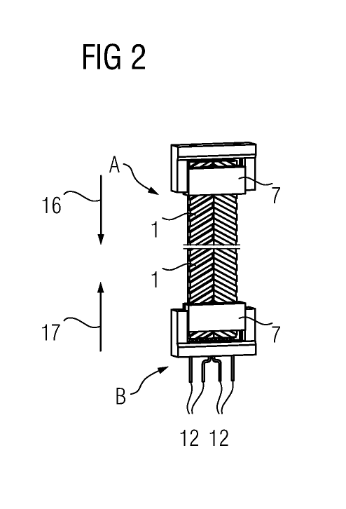

FIG. 2 shows a perspective view of the arrangement wherein the means 3 for measuring of the electric resistance comprise a connector 7 at the end of the traction belt A, B making group-wise an electric connection between the groups G1, G2 and the means 3 for measuring the electric resistance. The connector 7 is preferably a comb-like connector. The needles of the comb-like connector 7 may contact with the steel ropes 2, 2′ inside the traction belt 1. It is obvious that the steel ropes 2, 2′ of the traction belt also can be peeled in the area of the connector 7 before connecting the connector 7 to the steel ropes 2, 2′. A heating of the traction belt 1 can be utilized to softening the polymer of the traction belt 1 when making an electric connection between the steel ropes 2, 2′ and the connector 7.

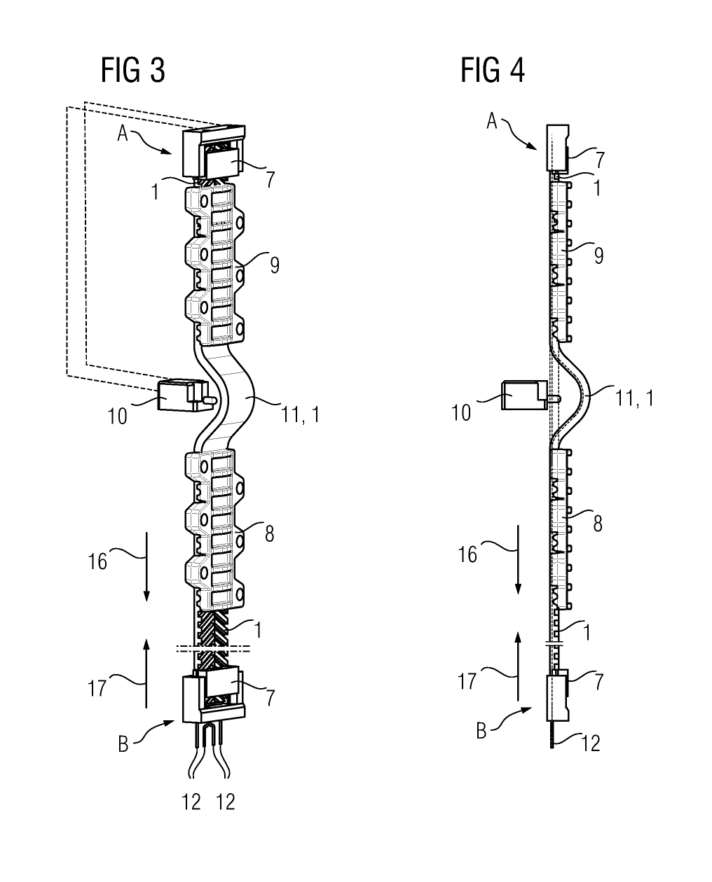

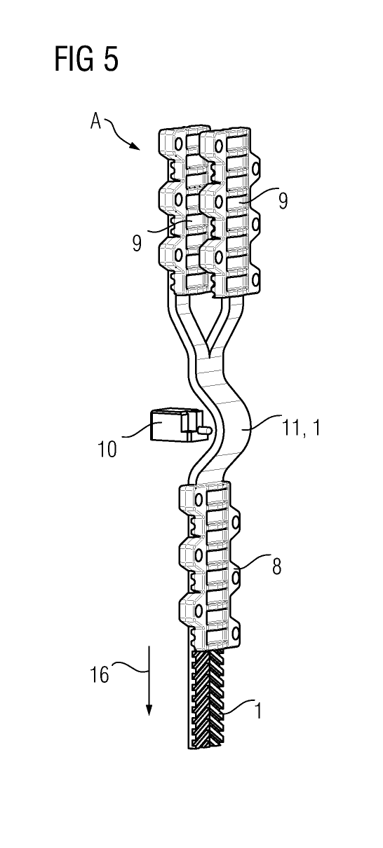

FIGS. 3 and 4 show the arrangement wherein the condition monitoring means 14 for condition monitoring of a termination of the traction belt 1 comprise a prime clamp 8, at least one supplementary clamp 9, a monitoring switch 10 between the prime clamp 8 and the supplementary clamp 9 and at least one traction belt 1 forming a slack bend 11 at the location of the monitoring switch 10. The slack bend 11 of the traction belt 1 and the monitoring switch 10 are mutually so positioned that a rupture of the prime clamp 8 causes the traction belt 1 to change a switch state of the monitoring switch 10. The monitoring switch 10 can be switch-off or alarming type.

The prime clamp 8 is before the supplementary clamp 9 seen from the direction of the traction 16, 17.

The condition monitoring means 14 for condition monitoring of a termination of the traction belt 1 can be mounted to the one end A, B of the traction belt 1 or to the both ends of the traction belt A, B.

FIG. 4 shows a situation when a rupture of the prime clamp 8 causes the traction belt 1 to change a switch state of the monitoring switch 10. The traction belt 1 after straighten the slack bend is illustrated with dashed lines.

One end A, B of the traction belt 1 is fixed by clamps 8,9 to the elevator car. The other end A, B of the traction belt 1 is preferably fixed to the counterweight or to compensating weights via a machine station. One end A, B of the traction belt 1 can be fixed also to a fixed structure of the hoistway. The traction belt 1 is preferably a toothed belt.

The monitoring switch 10 is preferably connected or connectable to the means 3 for measuring the electric resistance of the steel ropes 2, 2′ of each independent group G1, G2. This kind of connection can reduce the number of electric cables especially when the traction belt 1 is connected to the counterweight or to compensating weights.

The rupture of a termination of the prime clamp 8 and transfer of the load from the prime clamp 8 to the supplementary clamp 9 can also be detected by making the connector 7 in such a way that the connector 7 can breaks away when the load transfer to the supplementary clamp 9.

In one embodiment of the present invention the supplementary clamp 9 may be duplicated or duplicable to each independent group G1, G2.

In a method for condition monitoring of the traction belt 1 of an elevator or/and a termination of a traction belt 1 the arrangement 20 for condition monitoring of the traction belt 1 of an elevator or/and a termination of a traction belt 1 according to the first aspect of the present invention is used for condition monitoring of the traction belt 1 of an elevator or/and a termination of a traction belt 1.

An elevator comprises a hoistway, at least one elevator unit movable in the hoistway, including at least one elevator car, lifting means comprising a lift device, one or more suspension ropes and at least one traction belt 1 and an arrangement for condition monitoring of a traction belt 1 of an elevator and/or a termination of a traction belt 1 according to the first aspect of the present invention. In one embodiment the elevator comprises only one traction belt 1.

In the method for evaluating the way how traction belts 1 wear, the electric resistance values of each independent group G1, G2 of at least two traction belts 1 are compared to find out the way how the traction belts 1 wear. When collecting and comparing electric resistance values of different traction belts and collecting this data the data from the wearing of the traction belts in different environments and load conditions can be collected. Maintenance needs can be anticipated according to this collected data.

In the method for condition monitoring of a traction belt and/or a termination of traction belt the traction belt/the termination is divided in portions, which each portion capable to carry at least the intended load of the traction belt, a criterion for each of the portions of the traction belt and/or the termination of traction belt is set to judge a failure, if one or more such a criterion is met then a failure in capacity to carry the load is indicated.

In the method for condition monitoring of a traction belt and/or a termination of traction belt the traction belt is divided in portions by dividing the steel ropes 2, 2′ at least two independent groups G1, G2, measuring the electric resistance of the steel ropes 2, 2′ of each independent group G1, G2 and detecting condition or rupturing of the traction belt 1 by the means 3 for measuring the electric resistance of the steel ropes 2, 2′ of each independent group G1, G2.

In the method for condition monitoring of a traction belt and/or a termination of traction belt the termination is divided in portions by installing a prime clamp 8, at least one supplementary clamp 9, a monitoring switch 10 between the prime clamp 8 and the supplementary clamp 9 and at least one traction belt 1 forming a slack bend 11 at the location of the monitoring switch 10. The slack bend 11 of the traction belt 1 and the monitoring switch 10 are positioned mutually so that a rupture of the prime clamp 8 causes the traction belt 1 to change a switch state of the monitoring switch 10.

In the method for condition monitoring of a traction belt and/or a termination of traction belt the termination is divided in portions by doubling the supplementary clamp 9 for each independent group G1, G2.

In the method for condition monitoring of a traction belt and/or a termination of traction belt the load is intended in elevator control (EC).

In the method for condition monitoring of a traction belt and/or a termination of traction belt the criterion is set in elevator control (EC).

It is obvious to the skilled person that, along with the technical progress, the basic idea of the invention can be implemented in many ways. The invention and its embodiments are thus not limited to the examples described above but they may vary within the contents of patent claims and their legal equivalents.

### LIST OF REFERENCE NUMERALS USED

EC elevator control
A end of traction belt
B end of traction belt
1 traction belt
2 steel rope
2′ steel rope
3 means for measuring an electric resistance
4 monitoring limit
5 warning limit
6 alert limit
7 connector
8 prime clamp
9 supplementary clamp
10 monitoring switch
11 slack bend
12 electric cable
13 condition monitoring means
14 condition monitoring means
16 direction of traction
17 direction of traction
20 arrangement
21 microcontroller
22 condition monitoring means
23 comparing unit

1. An arrangement for condition monitoring of a traction belt and/or a termination of a traction belt, the arrangement comprising at least two independent condition monitoring means.

2. The arrangement according to claim 1, wherein: the condition monitoring means for condition monitoring of a traction belt of an elevator comprise:
at least two steel ropes inside the traction belt, which steel ropes cover the entire length between the opposite ends of the traction belt and are divided or dividable in at least two independent groups; and
means for measuring the electric resistance of the steel ropes of each independent group;
and wherein:
the means for measuring the electric resistance of the steel ropes of each independent group are configured to detect condition or rupturing of the traction belt.

3. The arrangement according to claim 1, wherein: the steel ropes inside each independent group are connected or connectable in series to enable measuring the electric resistance at only one end of the traction belt.

4. The arrangement according to claim 1, wherein: the condition monitoring means further comprise a condition monitoring means to which at least one monitoring limit for the electric resistance of the steel ropes of each independent group is determined or determinable.

5. The arrangement according to claim 1, wherein: the limit or at least one of said limits is a warning limit.

6. The arrangement according to claim 1, wherein: limit or at least one of said limits is an alarm limit.

7. The arrangement according to claim 1, wherein: the means for the electric resistance measuring comprise a connector at the end of traction belt making groupwise an electric connection between the groups and the means for measuring the electric resistance.

8. The arrangement according to claim 1, wherein: the connector is a comb-like connector.

9. The arrangement according to claim 1, wherein: the condition monitoring means for condition monitoring of a termination of a traction belt comprise:
a prime clamp;
at least one supplementary clamp;
a monitoring switch between the prime clamp and the supplementary clamp; and
at least one traction belt forming a slack bend at the location of the monitoring switch;
and wherein:
the slack bend of the traction belt and the monitoring switch are mutually so positioned that a rupture of the prime clamp causes the traction belt to change a switch state of the monitoring switch.

10. The arrangement according to claim 1, wherein: the monitoring switch is connected or connectable to the means for measuring the electric resistance of the steel ropes of each independent group.

11. The arrangement according to claim 1, wherein: the supplementary clamp is duplicated or duplicable for each independent group.

12. The arrangement according to claim 1, wherein: the traction belt is a toothed belt.

13. A method for condition monitoring of a traction belt and/or a termination of a traction belt, wherein: in the method the arrangement according claim 1 is used for condition monitoring of a traction belt of an elevator and/or a termination of a traction belt.

14. An elevator comprising:
a hoistway;
at least one elevator unit movable in the hoistway, including at least one elevator car;
lifting means comprising a lift device, one or more suspension ropes and at least one traction belt; and
an arrangement for condition monitoring of a traction belt of an elevator and/or a termination of a traction belt according to claim 1.

15. The elevator according to claim 1, wherein: the elevator comprises only one traction belt.

16. A method for evaluating the way how traction belts wear, wherein: the electric resistance values of each independent group of at least two traction belts are compared to find out the way how the traction belts wear.

17. A method for condition monitoring of a traction belt and/or a termination of traction belt, wherein:
the traction belt and/or termination of traction belt is divided in portions, each portion being capable to carry at least the intended load of the traction belt;
at least one criterion for each of the portions of the traction belt and/or the termination of traction belt is set to judge a failure; and
if one or more of the at least one criterion is met then a failure in capacity to carry the load is indicated.

18. The method according to claim 17, wherein: the traction belt is divided in portions by
dividing steel ropes of the traction belt at least two independent groups;
measuring the electric resistance of the steel ropes of each independent group; and
detecting condition or rupturing of the traction belt by the means for measuring the electric resistance of the steel ropes of each independent group.

19. The method according to claim 17, wherein: the termination is divided in portions by installing:
a prime clamp;
at least one supplementary clamp;
a monitoring switch between the prime clamp and the supplementary clamp;
at least one traction belt forming a slack bend at the location of the monitoring switch;
and
by positioning mutually the slack bend of the traction belt and the monitoring switch so that a rupture of the prime clamp causes the traction belt to change a switch state of the monitoring switch.

20. The method according to claim 17, wherein: the termination is divided in portions by duplicating a supplementary clamp for each independent group.

21. The method according to claim 17, wherein: the load is intended in elevator control.

22. The method according to claim 17, wherein: the criterion is set in elevator control.
